(19) United States
(12) Patent Application Publication
(10) Pub. No.: US 2003/0060262 A1
(43) Pub. Date: Mar. 27, 2003

(54) Sports lotto

(76) Inventor: Shane Antony Yeend, Kent Town (AU)

Correspondence Address: NATH & ASSOCIATES PLLC, 6th Floor, 1030 15th Street, NW, Washington, DC, 20005, US

(21) Appl. No.: 10/197,265

(22) Filed: Jul. 18, 2002

(30) Foreign Application Priority Data
Sep. 25, 2001 (AU) PR7915

(51) Int. Cl. A63F 13/00

(52) U.S. Cl. 463/17; 463/42

(57) ABSTRACT

A method of promotion of television programs of events such as sporting contests which involves combining selecting one lottery number at a time from a set to select a winning combination each selection being triggered by an observer triggering a selection at a time coinciding with a pre established happening in the event. There is also disclosed the use of a clock or a computer program providing a clock output which is associated with the event which also is used to select on a random or on a pseudo random basis the numbers of the winning combination.

### FIELD OF THE INVENTION

The present invention relates to a promotional arrangement and method particularly involving a game of chance with a televised event such as a sporting competition, reality TV show, Game show, live broadcast, or music event.

### BACKGROUND OF THE INVENTION

The lottery industry is crowded with many products all of which provide a game of chance to participants. Those within the industry require innovative ideas and products to maintain revenue. These products generally have rules that are different for different games, and varying odds of winning, however, essentially they provide a system whereby a user purchases a gaming ticket, and depending on the combination of numbers randomly selected from a barrel or the like the participant may have a winning ticket.

Unlike other industries, which have been able to cross license, lotteries have been unable to tap licensed brands and follow changes in the market. Although lotteries use television programs to drive sales, these are often limited to short segments wedged between prime time programming. It is noted, however that due to the popularity of lotteries, these short segments generally achieve high ratings.

The lottery industry whilst being a relatively mature industry, has to date been unable to branch out into other mainstream activities. It would be of great value to provide a new lottery system which enables the lottery industry to expand into other areas, and also for them to take advantage of the popularity and high ratings of existing events such as sporting contests.

### OBJECTS OF THE INVENTION

It is an object of the present invention to provide a method in one case and an apparatus in another that will be of assistance to expand the market for lotteries and also assist in promotion of sporting contests, reality TV shows, Game shows, live broadcasts, music events or the like.

### SUMMARY OF THE INVENTION

The present invention provides, in one aspect, a lottery system wherein lottery results are linked to an event, said system being adapted to effect a selection of one or more indicia on a random or pseudorandom basis but when predetermined occurrences happen during said event.

In a further form the invention can be said to reside in a method of operating a lottery system wherein lottery results are linked to occurrences happening during an event by having a number or indicia selection to establish what is a winning combination of these, the method including the steps of selecting one at a time a number or other indicia by the step of a person triggering a random or pseudo random selection the triggering being activated by the person upon each of predetermined occurrences occurring during said event.

In a further form the invention can be said to reside in method of operating a lottery system further characterized in that the event is a sporting event and the occurrences are those that will inevitably occur as a direct result of the sporting contest but at a time that cannot be reliably predicted.

In a further form the invention can be said to reside in a method of operating a lottery system further characterized in that the method includes broadcasting the event through television or the internet and having a display together of the ongoing event and the results of any selection of any winning number or other indicia.

In a further form the invention can be said to reside in a lottery system including a clock system adapted to cycle through an available set of numbers or other indicia, such that when each of predetermined occurrences happen during an event a readout of the clock is momentarily selected by an observer so that the number resulting is a random or pseudo random number or other indicia and the available number or other indicia is indicated by the clock is selected.

In preference the system includes a clock that is associated with a time keeping function of a sporting contest, reality TV show, Game show, live broadcast, music event or the like and is associated with a selection of an unpredictable choice of a number or indicia from a selected set of numbers or indicia.

In one preferred arrangement the clock is arranged to cycle through available numbers, such that when a predetermined occurrence happens the system is triggered so that the clock is momentarily suspended and one of the still available numbers or indicia from an originally selected range of numbers or indicia, which selection is randomly or pseudo randomly established, is indicated by the clock.

In another preferred form of the invention there is further proposed that the clock is a visual output from a computer program which is displayed as a clock with appropriate numbers for a time display including hours and minutes and which computer program also when activated for this purpose is adapted to select in a way that is not predictable, one of a set of indicia, and thereafter, the computer program will be further adapted, when activated for this purpose, to select in a way that is not predictable a further one of the set of indicia and again repeat this until all of a selected total of the indicia from the set of indicia have been obtained.

In a further form the invention can be said to reside in a method of increasing attractiveness of a program to a television audience which includes the steps of playing a game of chance where a number of television watchers can participate including the steps of providing each of the participants with combinations of indicia which are, at least in the main, different either by reason of the individual indicia or their sequence for each participant, where there are the further steps of finding a winning combination of such indicia by observing an event over a period of the event, establishing previously which of observable results will be used to trigger a selection of one or more of indicia, the selection of one or more of indicia being by way of selection through a random or pseudo random indicia generator triggered to provide a selection of an indicia at the time of the chosen observable result occurring in the event and displaying the result through a television network while the event is being broadcast and at the same time or soon after the observable result occurs.

In preference, the indicia are numbers.

In preference, the television broadcast shows a clock where the time of the observable result is discernable and the random or pseudo random generator is coupled to the clock so that there is a link affecting a selection of the indicia with the time of the observable result. “Clock” as well as “RNG” etc.

In preference the invention can be said to reside in a method of increasing interest in an event being broadcast through television which includes a game of chance where a number of television watchers can participate including the steps of providing each of the participants with combinations of indicia which are, at least in the main, different either by reason of the indicia or their sequence for each participant, where there are the further steps of finding a winning combination of such indicia by observing a sporting contest over a period of the play of that contest, establishing previously which, of observable specific results will be used to trigger a selection of one or more of indicia, the selection of one or more of indicia being by way of selection through a random or pseudo random indicia generator triggered to provide a selection of an indicia at the time of the chosen observable result occurring in the event, and displaying the result through a television channel while the sporting contest is being broadcast on that channel and at a time of the observable result occurring.

The event can be in a widest interpretation any event such as sporting competitions, reality TV shows, Game shows, live broadcasts, music events where there are going to be occurrences that will occur at times that can not be precisely predicted. Persons watching the event unfold then will build up expectation waiting for this expected but essentially unpredictable time to trigger a selection of a lucky result for them.

In preference the pseudo random generator is a timer which includes a display output that is available when triggered and the display is one of a selected indicia that is selected at the time of the triggering and the indicia are those remaining to be chosen for the method.

In preference the method is further characterized in that the pseudo random generator cycles through the remaining indicia at a speed that makes it substantially impossible to predict which of the indicia will be selected upon any triggering.

In preference the method is further characterized in that the clock is a visual output from a computer program which is displayed as a clock with appropriate numbers for a time display including hours and minutes and which computer program also when activated for this purpose is adapted to select in a way that is not manually predictable one of a set of indicia, and thereafter, the computer program will be further adapted, when activated for this purpose, to select in a way that is not manually predictable a further one of the set of indicia and again repeat this until all of a selected total of the indicia from the set of indicia have been obtained.

In a further alternative form of the invention this can be said to reside in an arrangement for encouraging audience participation for those watching a sporting contest on television which includes having at least one of the participants having a combination of indicia, a display on the screen of a television receiver video display unit wherein there is adapted to be provided during a sporting event a representation effecting a display of a time of the day or a time period through which the event has passed and on the screen at the same time or in conjunction with the same time display one or more but not all of a group of indicia which are adapted to be available for selection from time to time and that such an indicia is displayed when chosen by correlation with an occurrence of an observable event in the sporting event, the one or more indicia being displayed being selected from the total group of indicia or a remainder total group where those indicia that have been previously selected during the same sporting event are not in the group,

In a further alternative form of the invention this can be said to reside in a method of assisting the playing of a game of chance which includes the steps of effecting a display on the screen of a television receiver video display unit wherein there is provided during a sporting event a display of a time of the day or a time period through which the event has passed and on the screen at the same time or in conjunction with the same time display one or more but not all of a group of indicia which are available for selection either in sequence or from time to time and that such an indicia is displayed when chosen by correlation with the time of an occurrence of a happening in the sporting event, the one or more indicia being displayed at any one time being randomly or pseudo randomly selected from the total group of indicia or a remainder total group where those indicia that have been previously selected during the same sporting event are not in the remainder group to be selected.

In a further alternative form of the invention this can be said to reside in a method of promotion of television programs of sporting contests which involves combining selecting one lottery number at a time from a set to select a winning combination each selection being at a time coinciding with a pre-established happening in the sporting contest.

### BRIEF DESCRIPTION OF THE DRAWINGS

FIGS. 1 to 4 show flow diagrams of one embodiment of the present invention.

FIG. 5 shows an example of a clock display for use with the present invention.

### DETAILED DESCRIPTION OF PREFERRED EMBODIMENTS

The program sets up an array of numbers just like the balls in a barrel. The number of balls in the barrel is a value called “range”.

When the STOP button is pushed to select a “ball”, the program runs a pseudo random number generator sub-routine, which returns a number between 0 and “range”. It does this by using a mathematical algorithm, which produces a pseudo random bit sequence. It selects 6 of these bits (which gives a number between 0 and 63 inclusive) and if that number is less than “range”, that is the result—otherwise it loops until it gets a number which is less than “range”.

The element of the array corresponding to “range” is selected as the “dropped ball”. (I.e. if the returned value is 10 the 10th element in the array is selected. Range is decremented by one, and all the elements of the array “shuffled up” to fill the place of the dropped ball.

The present invention seeks to link a game of chance such as a traditional lottery game with other activities, and in particular sporting events. A basic premise of the present invention is that a selection of generated random or pseudo random indicia (usually numbers) for a lottery is not controlled by selection from a barrel or the like, but rather is generated by events in a linked event, for example a football game. Various observable events which are previously established to be occurring throughout the contest or game can be used to trigger a selection and hence a generation of a lottery number. In this way, each participant is able to combine a number of interests, and also adds extra excitement to the watching of the sporting contest. This approach has the advantage, that high ratings of lottery draws may be sustained over the entire game, as the first number may be determined when one football team kicks the first goal of a game. Alternatively, a number may be selected when the leading driver completes the fourth lap of a Grand Prix race.

A first preferred embodiment utilises a computer with a clock function that appears to generate a lottery number when the simulated clock is “stopped”. Using this same simile, a fractions “hand” of the “clock” may contain typically 36 or so numbers as opposed to the standard tenths or hundredths of seconds. If this number of places is cycling through every one tenth of a second then the possibility for anyone to be able to predict a result by manually selecting the instant of the selection is non existent. Continuing the explanation as applied to a theoretical clock then a number that the clock is stopped on following an occurrence during the event will be extracted for the fractions “hand” and the clock recalibrated to 35 numbers. And so the process will continue until 6 winning and 2 supplementary numbers have been generated and the game has been completed. The clock may be featured during live sporting events, however the appearance of the clock is not important, for example any analog, digital, or any other representation could be used.

Similarly, the lottery numbers, if displayed, may be shown on a separate clock to that of the game clock. This enables existing clocks to be maintained, and also provides for linking of the lottery system to time independent events or sports such as bowling.

Obviously, the numbers on the clock should correspond to the total number in the lottery. For example, if 45 numbers may be selected then the clock should contain 45 numbers initially. Similarly depending on the structure of the game any number of winning numbers may be drawn as opposed to six winning numbers alone. Alternatively the system could be adapted for use in a bingo game whereby numbers are generated until a winner is found, or the numbers remaining after a selection has been removed may be the winning numbers, such that customers would be hoping that their numbers are not removed.

In an alternative embodiment there is provided a computer with a program that sets up an array of numbers called a “range” for instance 1 through 64, which may be chosen to be larger than any expected range of numbers required.

When a STOP button is activated to select a “number”, the program is arranged to run a pseudo random number generator sub-routine, which returns a number between 0 and “range”. It does this by using a mathematical algorithm which produces a pseudo random bit sequence which is used to predict that every number has an equal chance of being selected but by reason of sufficiently rapid cycle time e.g. 1 ms it would be impossible for someone to predict a result with a manual selection of stop time. In this instance it selects let us say for each activation of a stop button a one of 6 of these bits (which gives a number between 0 and 64 inclusive) and if that number is within the preset “range”, that is the result—otherwise it is arranged to loop until it gets a number which is less than “range”.

The element of the array corresponding to “range” is selected as the “dropped ball”. (I.e. if the returned value is 10 the 10th element in the array is selected. Range is decremented by one, and all the elements of the array “shuffled up” to fill the place of the dropped ball. The customer can participate by buying lottery tickets from any number of outlets which may include newsagents, lottery retail outlets at stadiums and online. These can be distributed to these outlets just as any other lotto tickets are. A lottery company may provide the infrastructure and retail distribution channels to produce and distribute the ticket product.

The customer can choose their lucky numbers as they would normally do when filling out a lottery ticket, or these may be generated randomly. Once completed, the ticket may be processed at the point of sale and the customer can walk away with their printed and registered lotto ticket.

For lottery results to be created a combination of indicia (numbers) are generated by a process that will insure fairness to all participants. For lottery results to be created the numbers may be generated by the system clock within designated weekly events. As opposed to the winning numbers being generated by the spinning and stopping of a plastic ball, the number is generated by the stopping or suspending of a display of the system clock so that at a moment of triggering the system clock stores a time at that instant with an observable event which occurs during sporting events.

The system may generate the numbers as events take place during the sporting event. The system clock display may take a variety of forms whether that is as a physical clock round clock face at a stadium or as a virtual clock shown as a series of numbers on a television screen. The system will drive the number generation process.

The system may be featured at the stadiums that are the venues for the aforementioned sporting events for example, a stadium where a football grand final will be played. A clock may also be featured as a graphic on the television channel that broadcasts the event.

The system and “clock” may then replace a plastic ball dispenser as a machine that currently is used to generate the numbers for the lottery each week however rather than watching a three minute program on a Saturday night, customers will be attracted to tune into a high profile sporting event during which the numbers for a lottery type game will be generated in response to events anticipated to occur but at an unpredictable time and the results published in a public forum.

Winning tickets may be presented at lottery outlets and newsagents for payment of winnings.

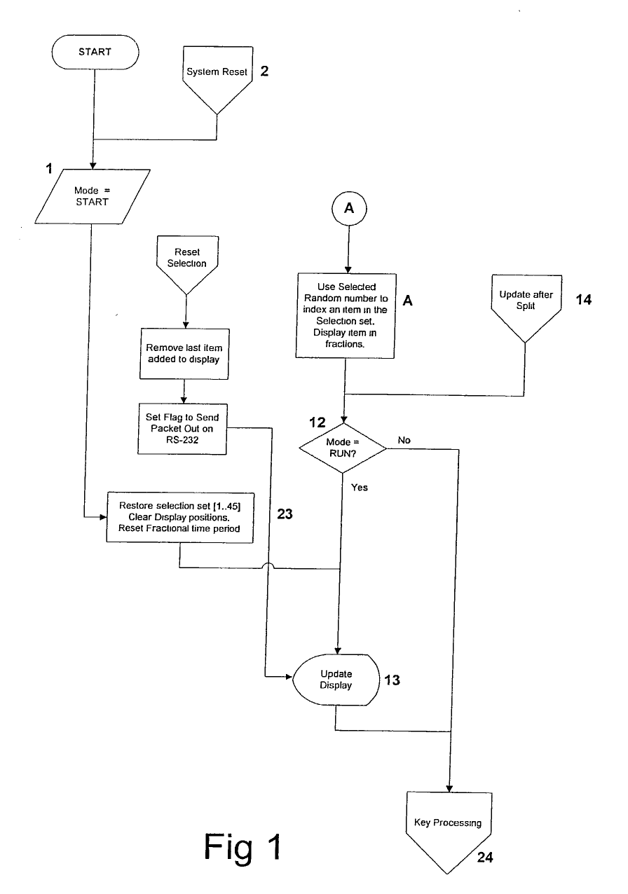

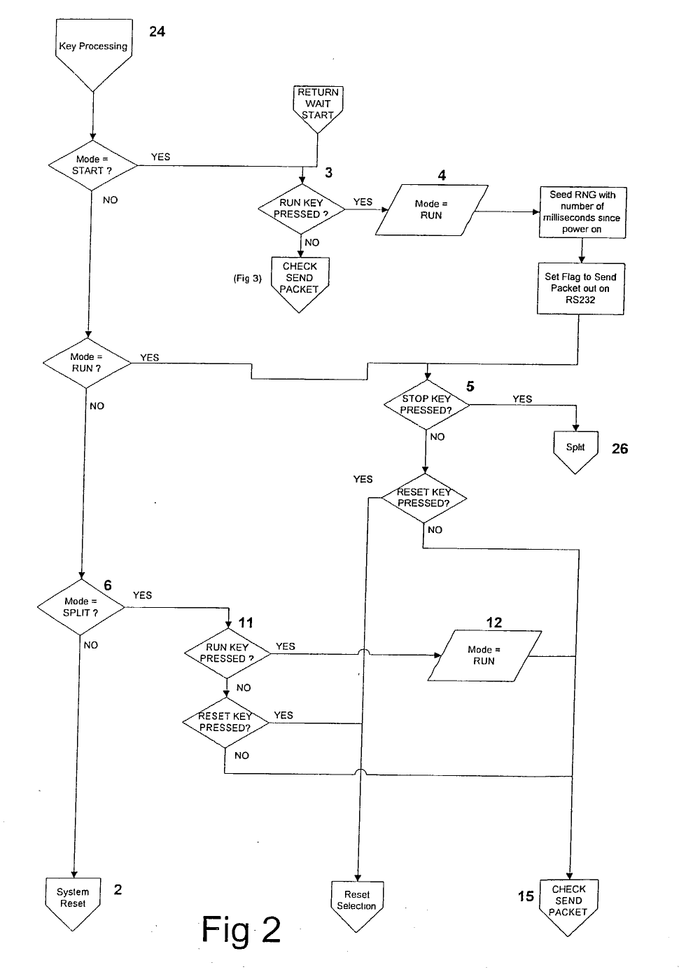

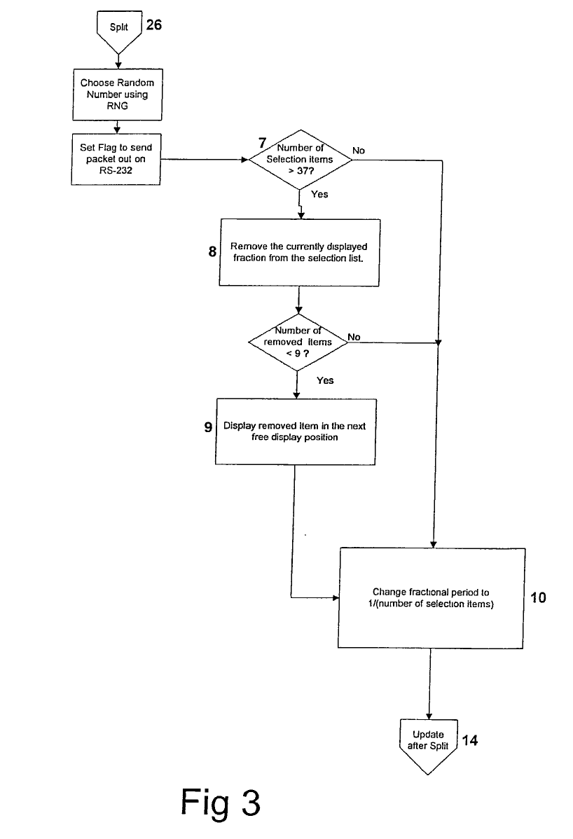

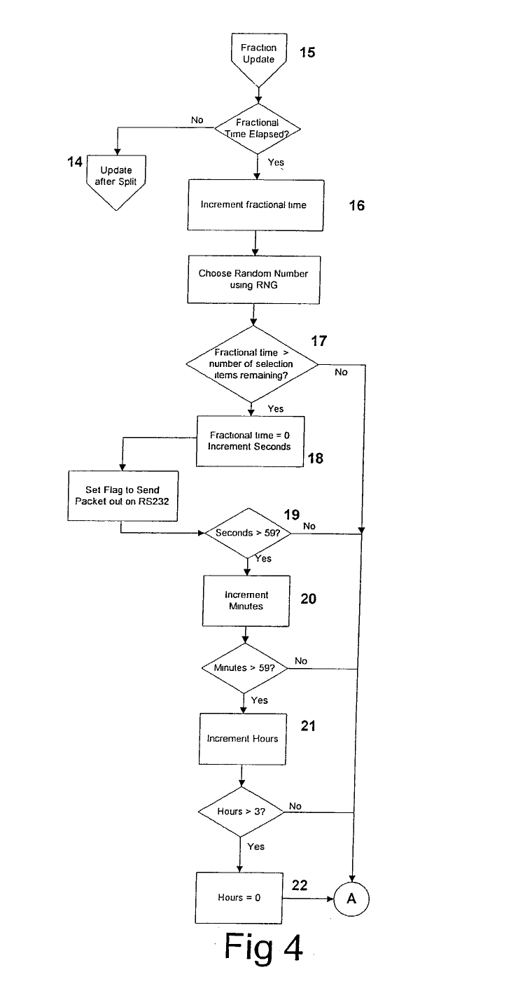

Now considering the generation of numbers in more detail, reference is made to attached FIGS. 1 to 4 that show the preferred arrangement.

The premise for this explanation is a lottery system that is played using a pool of 36 numbers from which must be chosen 6 winning numbers and 2 supplementary numbers.

At the beginning of a sporting event or game the system clock will be in start mode (1) the system will be at reset (2). The hours, minutes, seconds and fractions displays will be at reset (23) that will indicate all zero digits (13).

The system will then enter a key processing (24) stage with the clock in start mode (25).

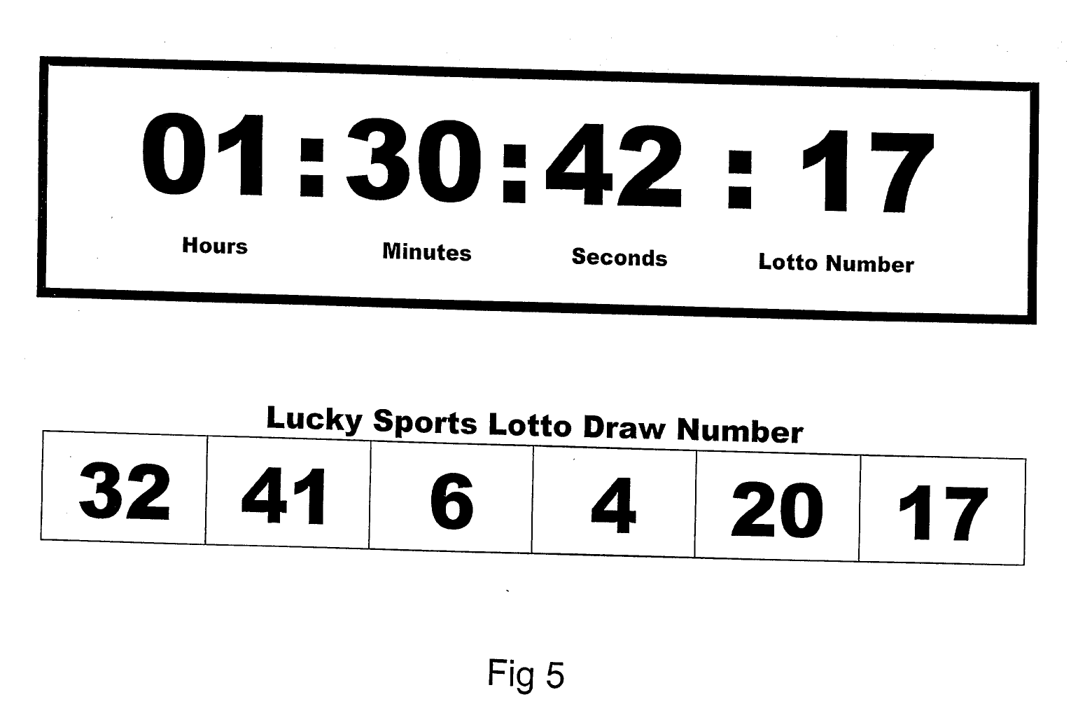

When the whistle or bell sounds for the event, the system clock (refer to FIG. 5) will be started by means of pressing a run key (3) thereby implementing run mode (4). Alternatively, the system may be configured to initiate the run key (3) automatically upon commencement of the event. For example, the run key (3) may be connected to the siren or game clock such that once the game is commenced the run key (3) is also activated. With the run key (3) pressed the system clock is in run mode (4).

At designated times during the event the system clock will be stopped (5) or suspended and will continue in split mode (6) for time dependent events. Split mode is when the actual movement of the digital numbers is stopped however the system clock process continues. For example, if the system clock is stopped on 2:34:22:09 for five seconds the system itself will continue to operate although this will not be apparent to the human eye. When the run key is pressed again (11), the clock will continue at 2:34:27:10 having recognised how long the digital numbers had been stationary. Whilst in split mode (26), the lottery number that the system clock has been stopped on (7) is removed from the selection list (8) and displayed in the free display position beneath the system clock (9). Alternatively, the removed number may simply be removed and not displayed, or displayed in any fashion.

For the system clock to visibly continue, given that whilst in split mode the clock has been continually running, the run key must be pressed (11), continue automatically or be activated automatically. The system clock is now back in run mode (12) with the display updated (13). As the first lottery selection number has been removed from the selection list and the clock (14) and the display updated, the fractional time period needs to be updated (15) so that the system clock can continue to function as any standard clock does thereby calculating hours, minutes, and seconds correctly.

The clock system update process takes into consideration how much incremental fractional time (16) has elapsed. Incremental fractional time is the amount of time that has elapsed between the visible clock being stopped, the lottery/selection number being removed and displayed, and the visible clock beginning again with the display updated. Given that a number has been removed from the fractional time period a calculation must take place for the system clock to continue to operate with correct timing. The real fractional time is going to be greater than the number of lottery/selection items remaining because one selection number has been displayed as the first lottery number.

For example, one second made up of 36 fractions will be longer than the period of time made up of the same 1/36 fractions but only multiplied by 35 which is the result of removing one lottery/selection number. Therefore, if the equivalent fractional time elapsed in seconds is not greater than the lottery/selection items (17) remaining then the fractional time is used to index an item in the lottery/selection set (A). This is the number that is first displayed when the display clock visibly continues.

If the fractional time equals (18) or is greater than 0 incremental seconds but less than 59 seconds (19) then the fractional time is used to Index an item in selection set (a). This is the number that is first displayed in the seconds display when the display clock visibly continues

If the fractional time is greater than 59 seconds (19) then the fraction update process calculates the changes that are required to similarly update the incremental minutes fractional time (20). In the context of an event or game this is unlikely to occur as it is presumed that the run key (11) will be activated less than 5 seconds after each lotto number is generated. Subsequently, system clock processes (21) and (22) are unlikely to be relevant.

The system clock is now in run mode and the system clock and display are updated and the first number has been selected and displayed. This continues until the second occurrence takes place in the event or game. At this point the stop key (5) is activated again, the system clock continues in split mode (6), the selected number is displayed (13) and the fraction update (15) indexes an item in the selection/lotto set (A).

And so the system clock continues for the duration of the event or game whereby 8 numbers are displayed below the system clock at the finish and the lottery draw has been completed.

In the example given it is considered that the lottery numbers will scroll through each part of a second, and that the entire clock display will be suspended for 5 seconds when an event is used to trigger. It will be understood that the system will continue in normal operation and that it is simply the display that will be apparently stopped although the number found will then be recorded for ongoing display or later download. This could be useful as the game or event nears completion, as viewers are unlikely to be happy with freezing of the game clock. Thus in split mode the seconds hands may continue to tick over. The system could be implemented such that each available number is scrolled through at a predetermined interval. Thus removing the need to calculate the fractional updates.

Alternatively, the fractional updates could be precalculated such that the system does not need to recalculate during operation. For time independent events or sports a predetermined timing interval will be required.

Consider now an example of how this could work within a sporting event. The lottery system could be linked to a game of Australian Rules football otherwise known as the Australian Football League (AFL). Two teams compete against each other and whoever kicks the most goals and thereby scores the most points wins the game.

For the purpose of this example the two teams are Carlton and Hawthorn.

Prior to the match, occurrences that are bound to happen during the upcoming match are selected. They can be a combination of kicks, handballs, marks, sirens, penalties etc. These occurrences would normally be published to customers, etc.

As an example, the 8 occurrences chosen may be:

First Carlton kick

First Hawthorn handball

Siren for end of 1^{st} quarter

First referees whistle in the 2^{nd} quarter

Siren for end of 2^{nd} quarter

Siren for end of 3^{rd} quarter

First Hawthorn kick in 4^{th} quarter (Supplementary No. 1)

Siren for end of the game (Supplementary No. 2)

The game begins. The system clock has been set at zero. The referees whistle signals the start of the match and the system clock begins.

A Carlton player kicks the ball and system clock display is stopped and the randomly selected lottery number is displayed on the system clock at the stadium and on the television picture.

A Hawthorn player handballs and the system clock display is stopped again. The selected number is displayed on the system clock, play continues, as does the system clock.

And so the process continues on with the remaining designated occurrences within the event taking place, the selected numbers being displayed, and the system clock continually updating the time and display mechanism.

When the final whistle sounds the last number is generated and the system clock is stopped for good. Eight numbers have been selected and are displayed on the system clock at the stadium and on television. These are the winning lottery numbers for the week's lotto prize draw.

Another example to be considered is a Formula One motor vehicle race. Cars race around a track at high speeds where the emphasis is on time and results.

Prior to the race, occurrences that are bound to happen during the upcoming race are selected. They can be a combination of the race start, the race finish, pit stops, number of laps completed etc. These occurrences will be published to customers. As an example, the 8 occurrences chosen may be:

Race begins

10^{th} lap completed

1^{st} pit stop

30^{th} lap completed

10^{th} pit stop

50^{th} lap completed

20^{th} pit stop

Race finish

The race begins. The system clock has been set at 0. The starters lights signals the start of the race and the system clock begins.

The leading driver completes the 10^{th} lap and the system clock display is stopped automatically and the selected lotto number is displayed on the system clock at the racetrack and on the television picture.

The race continues, as does the system clock.

A driver pulls in for a pit stop and the system clock display is stopped again. The selected number is displayed on the system clock, the race continues, as does the system clock.

And so the process continues with the remaining designated occurrences within the race taking place, the selected numbers being displayed, and the system clock continually updating the tie and display mechanism.

When the winning driver crosses the finish line and the chequered flag is waved the last number is generated and the system clock is stopped for good.

Eight numbers have been selected and are displayed on the system clock at the racetrack and on television. These are the winning lottery numbers for the week's lotto prize draw.

It is possible that second and subsequent division prizes will be won at the stadium/track, or by viewers at home.

The present system provides a number of advantages over conventional lotteries:

For example, the present invention provides a unique convergent package of media and brand licenses, which enables each entity to benefit commercially.

The lottery organisation's revenues increase and it is able to offer its' customers a more innovative product.

The sports organisation is able to generate revenues by receiving a fee in return for the right to use the matches within which the lottery numbers are generated. This income can be invested back into the sport and the clubs.

The television broadcaster will receive a fee for the right to use the media platform to deliver the product to the lottery customers. They also benefit by growing their own audiences. This leads to increased revenue.

That is, the lottery industry is provided with a new product, which can be cross licensed to high profile events. Similarly, the event organiser is presented with an opportunity to increase viewer participation and ticket sales.

Whilst the method and system of the present invention has been summarised and explained by illustrative application it will be appreciated by those skilled in the art that many widely varying embodiments and applications are within the teaching and scope of the present invention, and that the examples presented herein are by way of illustration only and should not be construed

1. A method of operating a lottery system wherein lottery results are linked to occurrences happening during an event by having a number or indicia selection to establish what is a winning combination of these the selection being by a person triggering a random or pseudo random selection which triggering is activated upon each of predetermined occurrences occurring during said event.

2. A method of operating a lottery system as in claim 1 further characterized in that the event is a sporting event and the occurrences are those that will inevitably occur as a direct result of the sporting contest but at a time that cannot be reliably predicted.

3. A method of operating a lottery system as in either of preceding claims 1 or 2 further characterized in that the method includes broadcasting the event through television or the internet and having a display together of the ongoing event and the results of any selection of any winning number or other indicia.

4. A lottery system including a clock system adapted to cycle through an available set of numbers or other indicia, such that when each of predetermined occurrences happen during an event a readout of the clock is momentarily selected by an observer so that the number resulting is a random or pseudo random number or other indicia and the available number or other indicia is indicated by the clock is selected.

5. A method of increasing interest in an event which includes a game of chance where a number of television watchers of the event can participate including the steps of providing means for each of at least some of the participants to have, each, a combination of indicia which are, at least in the main, different either by reason of the indicia or their sequence for each participant, where there are the further steps of finding a winning combination of such indicia by having an observer observe the event over a period of the event, establishing previously which, of observable specific results will be used to trigger a selection of one or more of indicia, the selection of one or more of indicia being by way of selection through a random or pseudo random indicia generator triggered to provide a selection of an indicia at the time of the chosen observable result occurring in the event, and displaying the result through a television channel while the event is being broadcast on that channel and at a time of the observable result occurring.

6. A method of increasing interest in a sporting contest which includes a game of chance where a number of television watchers can participate including the steps of providing each of the participants with combinations of indicia which are, at least in the main, different either by reason of the indicia or their sequence for each participant, where there are the further steps of finding a winning combination of such indicia by observing a sporting contest over a period of the play of that contest, establishing previously which, of observable specific results will be used to trigger a selection of one or more of indicia, the selection of one or more of indicia being by way of selection through a random or pseudo random indicia generator triggered to provide a selection of an indicia at the time of the chosen observable result occurring in the sporting contest, and displaying the result through a television channel while the sporting contest is being broadcast on that channel and at a time of the observable result occurring.

7. A method as in the immediately preceding claim further characterized in that the indicia are all numbers.

8. A method as in the immediately preceding claim further characterized in that the indicia are all letters.

9. A method as in any one of the preceding claims 3, 4 or 5 further characterized in that the random or pseudo random generator includes a timer and a display output that is available at the least when triggered and the display output is one or more of a selected indicia that is derived by the pseudo random or random generator at the time of the triggering and the indicia is or are those remaining from a preselected range

10. A method as in preceding claim 7 further characterized in that the pseudo random generator cycles through the remaining indicia at a speed that makes it substantially impossible to predict which of the indicia will be selected upon any triggering.

11. A method as in any one of the preceding claims further characterized in that the clock is a visual output from a computer program which is displayed as a clock with appropriate numbers for a time display including hours and minutes and which computer program also when activated for this purpose is adapted to select in a way that is not manually predictable one of a set of indicia, and thereafter, the computer program will be further adapted, when activated for this purpose, to select in a way that is not manually predictable a further one of the set of indicia and again repeat this until all of a selected total of the indicia from the set of indicia have been obtained.

12. An arrangement for encouraging audience participation for those watching a sporting contest on television which includes having at least one of the participants having a combination of indicia, a display on the screen of a television receiver video display unit wherein there is adapted to be provided during a sporting event a representation effecting a display of a time of the day or a time period through which the event has passed and on the screen at the same time or in conjunction with the same time display one or more but not all of a group of indicia which are adapted to be available for selection from time to time and that such an indicia is displayed when chosen by correlation with an occurrence of an observable event in the sporting event, the one or more indicia being displayed being selected from the total group of indicia or a remainder total group where those indicia that have been previously selected during the same sporting event are not in the group,

13. A method of assisting the playing of a game of chance which includes the steps of effecting a display on the screen of a television receiver video display unit wherein there is provided during a sporting event a display of a time of the day or a time period through which the event has passed and on the screen at the same time or in conjunction with the same time display one or more but not all of a group of indicia which are available for selection either in sequence or from time to time and that such an indicia is displayed when chosen by correlation with the time of an occurrence of a happening in the sporting event, the one or more indicia being displayed at any one time being randomly or pseudo randomly selected from the total group of indicia or a remainder total group where those indicia that have been previously selected during the same sporting event are not in the remainder group to be selected.

14. A method of promotion of television programs of sporting contests which involves combining selecting one lottery number at a time from a set to select a winning combination each selection being at a time coinciding with a pre-established happening in the sporting contest. There is also disclosed the use of a clock or a computer program providing a clock output which is associated with the sporting program which also is used to select on a random or on a pseudo random basis the numbers of the winning combination.
